(19) United States
(12) Patent Application Publication
(10) Pub. No.: US 2022/0236747 A1
(43) Pub. Date: Jul. 28, 2022

(54) FLIGHT CONTROL APPARATUS AND FLIGHT CONTROL METHOD

(71) Applicant: KDDI CORPORATION, Tokyo (JP)

(72) Inventor: Takaya TANAKA, Tokyo (JP)

(73) Assignee: KDDI CORPORATION, Tokyo (JP)

(21) Appl. No.: 17/412,794

(22) Filed: Aug. 26, 2021

(30) Foreign Application Priority Data
Jan. 25, 2021 (JP) 2021-009866

(51) Int. Cl. G05D 1/10; G08G 5/00; B64C 39/02; B64D 27/24; B60L 50/60; B60L 58/12

(52) U.S. Cl. CPC G05D 1/101; G08G 5/003; G08G 5/0013; B64C 39/024; B64D 27/24; G01C 21/20; B60L 58/12; B60L 2200/10; B64C 2201/027; B64C 2201/042; B64C 2201/141; B60L 50/60

(57) ABSTRACT

A flight control apparatus is a flight control apparatus for controlling a flight device operating by electric battery power supplied from a battery and includes a flight path acquisition unit that acquires a flight path, a flight control unit that causes the flight device to fly along the flight path, a battery remaining capacity acquisition unit that acquires a remaining capacity of the battery, and a specifying unit that specifies a charging facility for charging the battery, which corresponds to a position of the flight device, in which the flight control unit causes the flight device to fly to the specified charging facility and charge the battery, and then, causes the flight device to fly to the flight path, if the remaining capacity is less than or equal to a threshold value while the flight device flies along the flight path.

### BACKGROUND OF THE INVENTION

### Field of the Invention

The present invention relates to a flight control apparatus and a flight control method for controlling flight of a flight device.

Priority is claimed on Japanese Patent Application No. 2021-009866, filed Jan. 25, 2021, the content of which is incorporated herein by reference.

### Description of Related Art

PCT International Publication No. WO2018/198313 discloses a system that receives an input of the flight area of a flight device such as a drone and the purpose of flight, creates a flight path in accordance with the received area and the purpose, and controls the flight of the flight device in accordance with the created flight path.

### SUMMARY OF THE INVENTION

The flight device such as a drone includes a rechargeable battery and flies along the flight path using electric battery power supplied form the battery. In the related art, the remaining capacity of the battery when the flight device flies is predicted in advance, and the flight path is planned in advance such that the battery is charged in a drone port or the like at a certain point of the flight path in order to prevent insufficiency of a remaining capacity of the battery.

However, when the flight device actually flies, the flight device is affected by the wind, deterioration of the battery, and the like. Thus, there is a possibility that the remaining capacity of the battery is not the same as predicted. Accordingly, with the flight path planned in advance, the flight device cannot charge the battery by reaching the drone port, and the flight along the flight path may not continue.

Therefore, the present invention is conceived in view of such issues, and an object thereof is to enable a flight device that can fly using electric battery power to continue flying by charging the battery under various situations.

A flight control apparatus of a first aspect of the present invention is a flight control apparatus for controlling a flight device operating by electric battery power supplied from a battery and includes a flight path acquisition unit that acquires a flight path, a flight control unit that causes the flight device to fly along the flight path, a battery remaining capacity acquisition unit that acquires a remaining capacity of the battery, and a specifying unit that specifies a charging facility for charging the battery, which corresponds to a position of the flight device, in which the flight control unit causes the flight device to fly to the specified charging facility and charge the battery, and then, causes the flight device to fly to the flight path, if the remaining capacity is less than or equal to a threshold value while the flight device flies along the flight path.

The specifying unit may specify the charging facility closest to the position of the flight device if the remaining capacity is less than or equal to the threshold value.

The specifying unit may specify a charging path including a path from the position of the flight device to the specified charging facility and a path from the specified charging facility to the flight path, if the remaining capacity is less than or equal to the threshold value, and the flight control unit may cause the flight device to fly along the charging path if the remaining capacity is less than or equal to the threshold value while the flight device flies along the flight path.

The specifying unit may specify the charging path including a path from a position at which the flight device starts flying along the charging path to the specified charging facility, and a path from the specified charging facility to the position at which the flight device starts flying along the charging path.

The specifying unit may specify the charging path including a path from a deviation position advanced by a predetermined distance from a position at which the remaining capacity is less than or equal to the threshold value to the specified charging facility, and a path from the specified charging facility to the deviation position.

While the flight device flies along the flight path, the specifying unit may specify the threshold value based on a relationship between the position of the flight device and a position of the charging facility.

In addition to the relationship, the specifying unit may specify the threshold value based on a remaining work to be performed on the flight path by the flight device.

In addition to the relationship, the specifying unit may specify the threshold value based on a remaining length of the flight path.

In addition to the relationship, the specifying unit may specify the threshold value based on characteristics of the flight device.

The specifying unit may specify a plurality of the threshold values corresponding to a relationship between the position of the flight device and a position of each of a plurality of the charging facilities, and the flight control unit may cause the flight device to fly to any of the plurality of charging facilities based on situations of the plurality of charging facilities and the plurality of threshold values.

The specifying unit may specify the threshold value corresponding to a relationship, stored in advance in a storage unit, between any position on the flight path and a position of the charging facility.

The specifying unit may specify the threshold value corresponding to the relationship, stored in advance in the storage unit, between any position on the flight path and the position of the charging facility and characteristics of the flight device.

The flight control unit may cause the flight device to fly to the flight path if the remaining capacity is greater than or equal to a value corresponding to a remaining length of the flight path after the flight device starts charging in the specified charging facility.

The flight control unit may cause the flight device to fly to the flight path if the remaining capacity is greater than or equal to a value corresponding to the length and the remaining work to be performed on the flight path by the flight device after the flight device starts charging in the specified charging facility.

A flight control method of a second aspect of the present invention is a flight control method for controlling a flight device operating by electric battery power supplied from a battery and includes, by the execution of a processor, acquiring a flight path, causing the flight device to fly along the flight path, acquiring a remaining capacity of the battery, specifying a charging facility, corresponding to a position of the flight device, for charging the battery, and causing the flight device to fly to the specified charging facility and charge the battery, and then, causing the flight device to fly to the flight path, if the remaining capacity is less than or equal to a threshold value while the flight device flies along the flight path.

According to the present invention, an effect of enabling a flight device that flies using electric battery power to continue flying by charging the battery under various situations is achieved.

### BRIEF DESCRIPTION OF THE DRAWINGS

FIG. 1 is a schematic diagram illustrating a flight control system according to an embodiment.

FIG. 2 is a block diagram illustrating a flight control apparatus according to the embodiment.

FIG. 3 is a plan view illustrating a flight schedule screen for receiving an input of flight schedule information in a user terminal according to the embodiment.

FIG. 4 is a schematic diagram illustrating a control for flying a flight device by a flight control unit according to the embodiment.

FIG. 5 is a schematic diagram illustrating a method of specifying a sequential threshold value by a specifying unit during flight of the flight device according to the embodiment.

FIG. 6 is a schematic diagram illustrating a method of specifying the threshold value in advance by the specifying unit before the flight device flies, according to the embodiment.

FIGS. 7A and 7B are schematic diagrams illustrating a charging path specified by the specifying unit according to the embodiment.

FIG. 8 is a sequence chart illustrating a flight control method executed by the flight control system according to the embodiment.

### DETAILED DESCRIPTION OF EMBODIMENTS

### Summary of Flight Control System

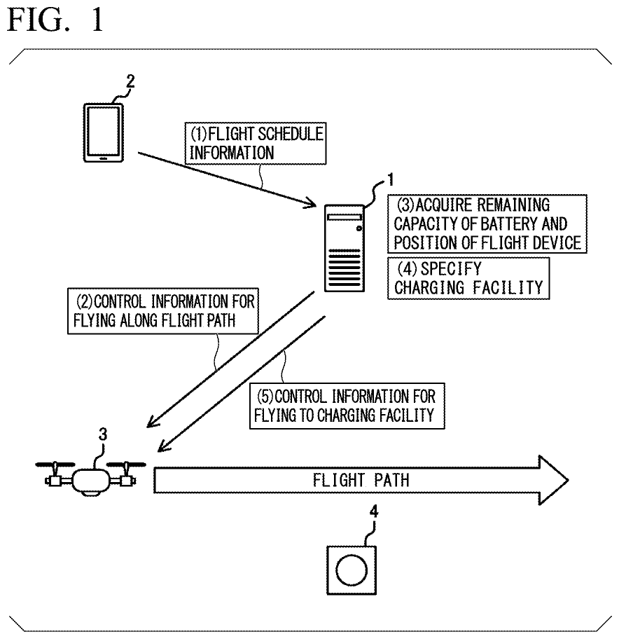

FIG. 1 is a schematic diagram of a flight control system according to the present embodiment. The flight control system includes a flight control apparatus 1, a user terminal 2, a flight device 3, and a charging facility 4. The flight control system may include other terminals, apparatuses, and the like.

The flight control apparatus 1 is a computer that specifies the charging facility 4 in a case where a remaining capacity of the battery included in the flight device 3 satisfies a predetermined condition, and performs a control for causing the flight device 3 to fly to the specified charging facility 4. The flight control apparatus 1 is a single apparatus or may be a plurality of apparatuses. In addition, the flight control apparatus 1 may be one or a plurality of virtual servers that operate on a cloud which is a set of computer resources.

The user terminal 2 is a computer used by a user. The user terminal 2 is an information terminal such as a smartphone, a tablet terminal, or a personal computer. The user is, for example, a person who operates, manages, or possesses the flight device 3. The user terminal 2 includes a display unit such as a liquid crystal display for displaying information and an operation unit such as a touch panel for receiving an operation performed by the user. The user terminal 2 transmits and receives information to and from the flight control apparatus 1 by communication.

The flight device 3 is an unmanned flight device such as a drone that flies on a flight path designated by the user and performs a predetermined work. In addition, the flight device 3 may be a manned flight device such as an airplane or a flyable vehicle. The flight device 3 includes a rechargeable battery and operates using electric battery power supplied from a battery. The work performed by the flight device 3 is, for example, transport of an object on the flight path, imaging around the flight path, release of an object (agrochemical or the like) on the flight path, or output of information (voice, light, or the like) on the flight path. The flight device 3 performs communication using a communication service provided by a communication carrier (referred to as a communication provider). In addition, the flight device 3 may function as the flight control apparatus 1 by executing at least a part of functions executed by the flight control apparatus 1.

The charging facility 4 is a facility for charging the battery included in the flight device 3. The charging facility 4 is, for example, a drone port on which the drone which is the flight device 3 can take off and land. For example, the charging facility 4 charges the battery of the flight device 3 by connecting to the flight device 3 landed on the charging facility 4 and supplying electric power to the flight device 3.

Hereinafter, a summary of processing executed by the flight control apparatus 1 according to the present embodiment will be described. The flight control apparatus 1 receives flight schedule information including the flight path on which the flight device 3 is scheduled to fly, from the user terminal 2 ((1) in FIG. 1).

The flight control apparatus 1 transmits control information for causing the flight device 3 to fly along the designated flight path to the flight device 3 ((2) in FIG. 1). The flight control apparatus 1 acquires the remaining capacity of the battery included in the flight device 3 and a position of the flight device 3 from the flight device 3 flying along the flight path ((3) in FIG. 1).

The flight control apparatus 1 specifies the charging facility 4, corresponding to the position of the flight device 3, for charging the battery included in the flight device 3 ((4) in FIG. 1). For example, the flight control apparatus 1 specifies the charging facility 4 closest to the position of the flight device 3 if the remaining capacity of the battery is less than or equal to a predetermined threshold value.

The flight control apparatus 1 transmits control information for causing the flight device 3 to fly to the specified charging facility 4 and causing the flight device 3 to fly to the flight path after charging the battery to the flight device 3 if the remaining capacity of the battery is less than or equal to the predetermined threshold value while the flight device 3 flies along the flight path ((5) in FIG. 1).

In such a manner, the flight control apparatus 1 according to the present embodiment dynamically specifies the charging facility 4 in accordance with the position of the flight device 3 flying along the designated flight path and the remaining capacity of the battery, and charges the battery by causing the flight device 3 to fly to the specified charging facility 4. Accordingly, according to the flight control apparatus 1, since the charging facility 4 to be used for charging the battery on the flight path does not need to be decided in advance, the flight device 3 can continue flying by charging the battery under various situations such as a case where the remaining capacity of the battery is quickly reduced due to an effect of a headwind.

Configuration of Flight Control Apparatus 1

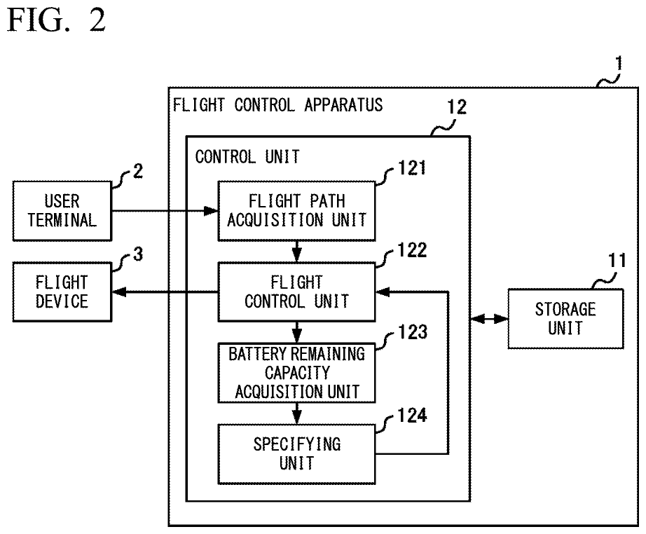

FIG. 2 is a block diagram of the flight control apparatus 1 according to the embodiment. In FIG. 2, arrows indicate a main flow of data, and a flow of data other than illustrated in FIG. 2 may be present. In FIG. 2, each block indicates a configuration in function units and does not indicate a configuration in hardware (device) units. Thus, the blocks illustrated in FIG. 2 may be implemented in a single apparatus or may be separately implemented in a plurality of apparatuses. Exchange of data between the blocks may be performed through any means such as a data bus, a network, or a portable storage medium.

The flight control apparatus 1 includes a storage unit 11 and a control unit 12. The storage unit 11 is a storage medium including a read only memory (ROM), a random access memory (RAM), a hard disk drive, and the like. The storage unit 11 stores, in advance, a program executed by the control unit 12. In addition, the storage unit 11 stores, in advance, charging facility information including a position of the charging facility 4.

The control unit 12 includes a flight path acquisition unit 121, a flight control unit 122, a battery remaining capacity acquisition unit 123, and a specifying unit 124. The control unit 12 is a processor such as a central processing unit (CPU) and functions as the flight path acquisition unit 121, the flight control unit 122, the battery remaining capacity acquisition unit 123, and the specifying unit 124 by executing the program stored in the storage unit 11. Each unit of the control unit 12 may be separately implemented in the plurality of apparatuses constituting the flight control apparatus 1. In addition, a processor of the flight device 3 may function as each unit of the control unit 12.

Hereinafter, a configuration for executing processing according to the present embodiment by the flight control apparatus 1 will be described. The flight path acquisition unit 121 receives the flight schedule information including the flight path on which the flight device 3 is scheduled to fly, from the user terminal 2.

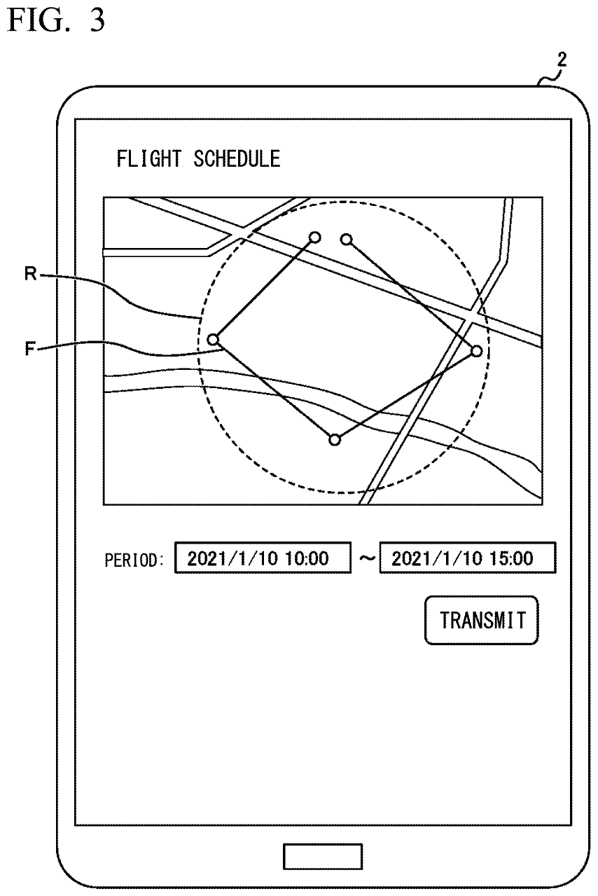

FIG. 3 is a schematic diagram of a flight schedule screen for receiving an input of the flight schedule information in the user terminal 2. For example, the user terminal 2 receives a planar range (flight area) designated on a map displayed on the flight schedule screen as a flight range R. In addition, the user terminal 2 receives a linear path designated in the flight range R on the map displayed on the flight schedule screen as a flight path F. In addition, the user terminal 2 may receive a designation of the flight path F and does not receive a designation of the flight range R.

In addition, the user terminal 2 may receive a designation of a flight schedule period in which the flight device 3 flies. The flight schedule period is, for example, a period that is designated by a start date and time and an end date and time. In addition, the user terminal 2 may receive a designation of a work content to be performed on the flight path by the flight device 3. The work content is a type of work such as imaging, monitoring, or delivery to be performed by the flight device 3. The work content may be designated for the entire flight path or may be designated for each point in the flight path. The user terminal 2 may receive an input of other information.

In the flight control apparatus 1, the flight path acquisition unit 121 acquires the flight schedule information including the flight path from the user terminal 2 based on each information input on the flight schedule screen. The flight path acquisition unit 121 stores the flight schedule information received from the user terminal 2 in the storage unit 11.

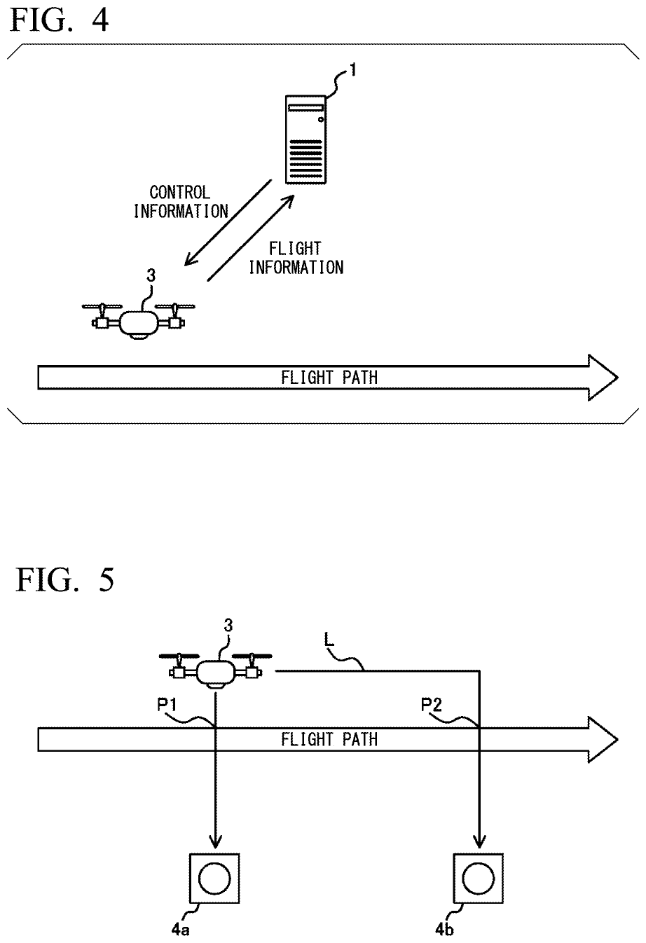

The flight control unit 122 performs a control for causing the flight device 3 to fly along the flight path acquired by the flight path acquisition unit 121. FIG. 4 is a schematic diagram for describing the control for causing the flight device 3 to fly by the flight control unit 122.

For example, the flight control unit 122 transmits the control information for flying along the flight path acquired by the flight path acquisition unit 121 to the flight device 3. The flight device 3 flies using the electric battery power along the flight path included in the control information received from the flight control apparatus 1.

In a case where the flight device 3 functions as the flight control apparatus 1, the flight control unit 122 included in the flight device 3 outputs the control information (for example, a control signal) for flying along the flight path acquired by the flight path acquisition unit 121 to a driving unit such as a motor included in the flight device 3. Accordingly, the flight device 3 flies along the flight path using the electric battery power.

The battery remaining capacity acquisition unit 123 acquires an electric capacity of the battery included in the flight device 3 while the flight device 3 flies along the flight path. The flight device 3 specifies the remaining capacity of the battery based on, for example, a voltage and specifies the position based on a global positioning system (GPS) signal or a base station (cell) with which the flight device 3 can communicate. The flight device 3 may specify a two-dimensional position represented by coordinates or may specify a three-dimensional position represented by coordinates and an altitude.

The flight device 3 transmits flight information including the specified remaining capacity of the battery and the position of the flight device 3 to the flight control apparatus 1. In the flight control apparatus, the battery remaining capacity acquisition unit 123 acquires the remaining capacity of the battery and the position of the flight device 3 included in the flight information received from the flight device 3.

In a case where the remaining capacity of the battery of the flight device 3 is less than or equal to the predetermined threshold value based on the flight information acquired by the battery remaining capacity acquisition unit 123, the specifying unit 124 specifies the charging facility 4, corresponding to the position of the flight device 3, for charging the battery. First, the specifying unit 124 specifies the threshold value used for determining the remaining capacity of the battery. The specifying unit 124 specifies a sequential threshold value while the flight device 3 flies, or specifies the threshold value in advance before the flight device 3 flies.

In a case where the specifying unit 124 specifies the sequential threshold value, the specifying unit 124 specifies the threshold value based on a relationship between the position of the flight device 3 included in the flight information acquired by the battery remaining capacity acquisition unit 123 and the position of the charging facility 4 included in the charging facility information stored in advance in the storage unit 11, while the flight device 3 flies along the flight path.

For example, if the flight device 3 reaches a predetermined determination position on the flight path, the specifying unit 124 calculates the remaining capacity of the battery with which flying can be performed in a distance from the position of the flight device 3 to the position of the next charging facility 4 present ahead along the flight path, using a relationship table or a relationship expression, stored in advance in the storage unit 11, that indicates a relationship between the remaining capacity of the battery of the flight device 3 and a flyable distance of the flight device 3, and specifies the calculated remaining capacity of the battery as the threshold value. In such a manner, by dynamically specifying the threshold value of the remaining capacity of the battery in accordance with a positional relationship between the flight device 3 and the charging facility 4, the flight control apparatus 1 can determine whether or not the charging facility 4 can be reached for each position of the flight device 3, and can reduce the number of times of charging.

FIG. 5 is a schematic diagram for describing a method of specifying the sequential threshold value by the specifying unit 124 during flight of the flight device 3. The specifying unit 124 specifies the threshold value if the flight device 3 reaches a determination position P1 on the flight path. For example, the determination position P1 is a position closest to a first charging facility 4a on the flight path (that is, a point from which the flight device 3 can reach the first charging facility 4a in the shortest distance). The determination position P1 is not limited thereto and may be a point or the like provided at a constant interval on the flight path.

At the determination position P1, a second charging facility 4b is present ahead along the flight path. A length of a path after the flight device 3 flies along the flight path from the determination position P1 and reaches the second charging facility 4b from a predetermined deviation position P2 will be referred to as a length L. For example, the deviation position P2 is a position closest to the second charging facility 4b on the flight path (that is, a point from which the flight device 3 can reach the second charging facility 4b in the shortest distance).

The specifying unit 124 calculates a threshold value corresponding to the length L using the relationship table or the relationship expression, stored in advance in the storage unit 11, that indicates the relationship between the remaining capacity of the battery of the flight device 3 and the flyable distance of the flight device 3. The specifying unit 124 uses the calculated threshold value for determining the remaining capacity of the battery of the flight device 3. In a case where the remaining capacity of the battery is less than or equal to the threshold value, the flight control unit 122, as will be described later, performs a control for causing the flight device 3 to fly to the first charging facility 4a closest to the determination position P1 at which the flight device 3 is positioned. That is, since there is a possibility that the flight device 3 cannot reach the second charging facility 4b in a case where the remaining capacity of the battery is less than or equal to the threshold value corresponding to the length L, the flight control unit 122 performs the control for causing the flight device 3 to fly to the closest first charging facility 4a.

In addition to the relationship between the position of the flight device 3 and the position of the charging facility 4, the specifying unit 124 may specify the threshold value based on a remaining length of the flight path. In this case, based on the flight path and the position of the flight device 3, the specifying unit 124 specifies a length from the position of the flight device 3 to an end point of the flight path as the remaining length of the flight path on which the flight device 3 flies. The specifying unit 124 specifies the threshold value based on the specified remaining length. For example, the specifying unit 124 increases the threshold value as the remaining length is longer, and decreases the threshold value as the remaining length is shorter.

Accordingly, by causing the flight device 3 to fly to the end point of the flight path without charging in a case where the remaining length of the flight path is short, and by causing the flight device 3 to fly to the charging facility 4 in a case where the remaining length of the flight path is long, the flight control apparatus 1 can suppress wastefulness such that, for example, the flight device 3 heads toward the charging facility 4 even in a case where the flight device 3 can complete the flight on the flight path without charging the battery.

In addition to the relationship between the position of the flight device 3 and the position of the charging facility 4, the specifying unit 124 may specify the threshold value based on a remaining work to be performed on the flight path by the flight device 3. In this case, the specifying unit 124 specifies the remaining work to be performed on the flight path by the flight device 3 based on the work content included in the flight schedule information and the position of the flight device 3. The specifying unit 124 specifies the threshold value based on the specified remaining work. For example, the specifying unit 124 increases the threshold value as an amount of the remaining work is larger, and decreases the threshold value as the amount of the remaining work is smaller. In addition, for example, in a case where a predetermined work (work such as imaging that consumes large electric power) is included in the remaining work, the specifying unit 124 sets the threshold value to be greater than that in a case where the predetermined work is not included.

In a case where the flight device 3 performs the work such as imaging consuming large electric power during the flight, there is a possibility that the flight device 3 cannot reach the charging facility 4 due to a rapid decrease in remaining capacity of the battery. Regarding this point, by specifying the threshold value of the remaining capacity of the battery in accordance with the remaining work as described above, the flight control apparatus 1 can suppress an event in which the flight device 3 cannot reach the charging facility 4.

In addition to the relationship between the position of the flight device 3 and the position of the charging facility 4, the specifying unit 124 may specify the threshold value based on characteristics of the flight device 3. In this case, the specifying unit 124 specifies the characteristics of the flight device 3 based on aircraft information about the flight device 3 stored in advance in the storage unit 11. The characteristics of the flight device 3 are properties of an aircraft of the flight device 3 that affect the flight, such as a flight speed and a weight. For example, in a case where the characteristics of the flight device 3 satisfy a predetermined condition (for example, in a case where the flight speed is less than or equal to a predetermined value, or in a case where the weight is greater than or equal to a predetermined value), the specifying unit 124 sets the threshold value to be greater than that in a case where the predetermined condition is not satisfied.

In a case where the flight speed of the flight device 3 is slow, there is a possibility that the flight device 3 cannot reach the charging facility 4 before the remaining capacity of the battery is exhausted. In addition, in a case where the flight device 3 is heavy, the remaining capacity of the battery is likely to be decreased. Thus, there is a possibility that the flight device 3 cannot reach the charging facility 4. Regarding this point, by specifying the threshold value of the remaining capacity of the battery in accordance with the characteristics of the flight device 3 as described above, the flight control apparatus 1 can suppress an event in which the flight device 3 cannot reach the charging facility 4.

In a case where the specifying unit 124 specifies the threshold value in advance, the specifying unit 124 specifies the threshold value corresponding to a relationship between any position on the flight path and the position of the charging facility 4 in advance before the flight device 3 flies along the flight path. For example, the specifying unit 124 calculates a distance between each charging facility 4 closest from each point of the flight path and the point of the flight path and sets the largest distance as a maximum distance from the flight path to the charging facility 4.

The specifying unit 124 calculates the remaining capacity of the battery corresponding to the maximum distance using the relationship table or the relationship expression, stored in advance in the storage unit 11, that indicates the relationship between the remaining capacity of the battery of the flight device 3 and the flyable distance of the flight device 3, and specifies the calculated remaining capacity of the battery as the threshold value.

The specifying unit 124 stores the specified threshold value in the storage unit 11. In a case where the flight device 3 flies along the flight path, the specifying unit 124 specifies the threshold value stored in advance in the storage unit 11. In such a manner, by using the threshold value of the remaining capacity of the battery calculated in advance in accordance with a positional relationship between the flight path and the charging facility 4, the flight control apparatus 1 does not need to calculate the sequential threshold value during the flight of the flight device 3 and can reduce a calculation amount.

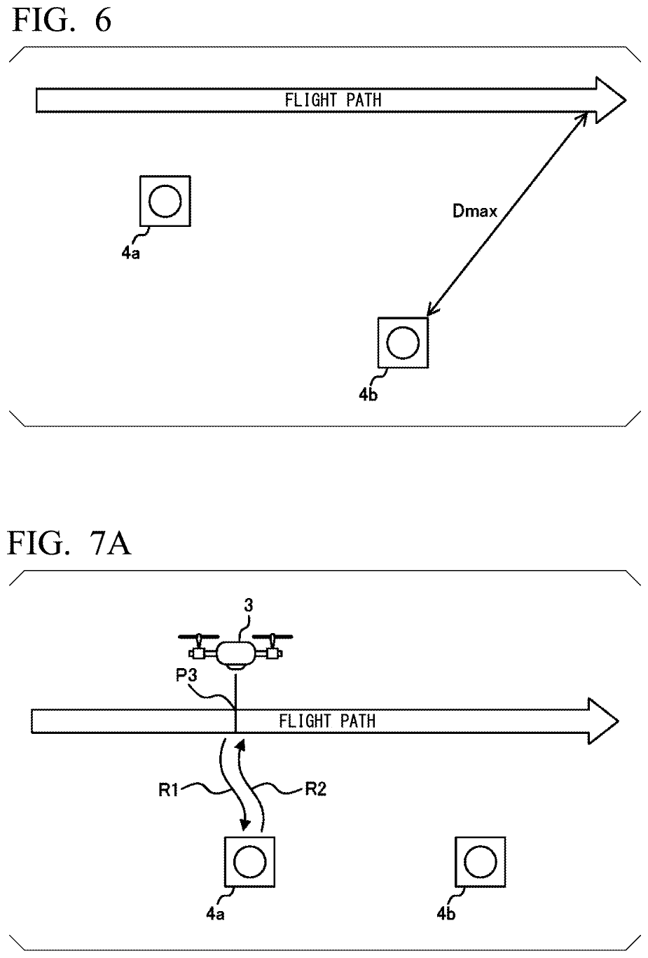

FIG. 6 is a schematic diagram for describing a method of specifying the threshold value in advance by the specifying unit 124 before the flight device 3 flies. In the example in FIG. 6, the charging facility 4b out of the plurality of charging facilities 4a and 4b is positioned furthest from any position on the flight path, and the maximum distance between the flight path and the charging facility 4b is a maximum distance Dmax. The specifying unit 124 calculates a threshold value corresponding to the maximum distance Dmax using the relationship table or the relationship expression, stored in advance in the storage unit 11, that indicates the relationship between the remaining capacity of the battery of the flight device 3 and the flyable distance of the flight device 3, and stores the threshold value in advance in the storage unit 11. The specifying unit 124 uses the threshold value stored in advance in the storage unit 11 for determining the remaining capacity of the battery of the flight device 3 during the flight. In a case where the remaining capacity of the battery is less than or equal to the threshold value, the flight control unit 122, as will be described later, performs a control for causing the flight device 3 to fly to the charging facility 4 closest to the current position of the flight device 3.

In the example in FIG. 6, the specifying unit 124 specifies a uniform threshold value corresponding to the maximum distance Dmax in advance. Instead, the specifying unit 124 may calculate a distance from each of a plurality of measurement reference positions (for example, positions closest from each charging facility 4 on the flight path, positions designated by a person, or a plurality of positions at constant intervals) on the flight path to the next charging facility 4 present ahead along the flight path, and store a threshold value corresponding to the calculated distance in advance in the storage unit 11 in association with the measurement reference position. The distance to the next charging facility 4 is, in the same manner as in FIG. 5, a length of a path after the flight device 3 flies along the flight path from the measurement reference position and reaches the next charging facility 4b from a predetermined deviation position. In this case, the specifying unit 124 uses the threshold value associated with the measurement reference position for determining the remaining capacity of the battery, if the flight device 3 during the flight reaches the measurement reference position. In a case where the remaining capacity of the battery is less than or equal to the threshold value, the flight control unit 122 performs a control for causing the flight device 3 to fly to the charging facility 4 closest from the measurement reference position.

In addition to the relationship between any position on the flight path and the position of the charging facility 4, the specifying unit 124 may specify the threshold value in advance based on the characteristics of the flight device 3. In this case, the specifying unit 124 specifies the characteristics of the flight device 3 based on the aircraft information about the flight device 3 stored in advance in the storage unit 11. The characteristics of the flight device 3 are the properties of the aircraft of the flight device 3 that affect the flight, such as the flight speed and the weight. For example, in a case where the characteristics of the flight device 3 satisfy the predetermined condition (for example, in a case where the flight speed is less than or equal to the predetermined value, or in a case where the weight is greater than or equal to the predetermined value), the specifying unit 124 sets the threshold value to be greater than that in a case where the predetermined condition is not satisfied.

The specifying unit 124 stores the calculated threshold value in the storage unit 11 in association with the characteristics of the flight device 3. In a case where the flight device 3 flies along the flight path, the specifying unit 124 specifies the threshold value associated with the characteristics of the flying flight device 3 in the storage unit 11. In a case where the flight speed of the flight device 3 is slow, there is a possibility that the flight device 3 cannot reach the charging facility 4 before the remaining capacity of the battery is exhausted. In addition, in a case where the flight device 3 is heavy, the remaining capacity of the battery is likely to be decreased. Thus, there is a possibility that the flight device 3 cannot reach the charging facility 4. Regarding this point, by specifying the threshold value of the remaining capacity of the battery in accordance with the characteristics of the flight device 3 as described above, the flight control apparatus 1 can suppress the event in which the flight device 3 cannot reach the charging facility 4.

The specifying unit 124 is not limited to a specific method illustrated here and may specify the threshold value used for determining the remaining capacity of the battery using other methods. For example, the specifying unit 124 may specify external factors such as a wind speed, a wind direction, and a temperature (that is, information about an environment including the flight device 3) that affect consumption of the remaining capacity of the battery, and simulate the flyable distance of the flight device 3 using the specified external factors. Based on a result of simulation, the specifying unit 124 specifies the remaining capacity of the battery with which the flight device 3 can reach the charging facility 4, as the threshold value. Accordingly, since the flight control apparatus 1 can specify the threshold value of the remaining capacity of the battery in which an effect of the external factors on the flight device 3 is considered, a probability that the flight device 3 can reach the charging facility 4 can be improved.

The specifying unit 124 specifies the charging facility 4 for charging the battery of the flight device 3 if the remaining capacity of the battery is less than or equal to the specified threshold value. For example, in a case where the remaining capacity of the battery is less than or equal to the specified threshold value, the specifying unit 124 specifies the charging facility 4 closest to the position of the flight device 3 as the charging facility 4 for charging the battery of the flight device 3. In addition, the specifying unit 124 may specify, out of a plurality of charging facilities 4, the charging facility 4 corresponding to the threshold value used for determining the remaining capacity of the battery as the charging facility 4 for charging the battery of the flight device 3.

The specifying unit 124 is not limited to a specific condition illustrated here and may specify the charging facility 4 on other conditions. In a case where the remaining capacity of the battery is greater than the specified threshold value, the specifying unit 124 repeats specifying the threshold value and determining the remaining capacity of the battery at predetermined time intervals.

In a case where the plurality of charging facilities 4 are installed near the flight path, the specifying unit 124 may select any of the plurality of charging facilities 4 as the charging facility 4 for charging the battery of the flight device 3 based on a plurality of threshold values corresponding to the plurality of charging facilities 4 and a situation of each of the plurality of charging facilities 4. For example, the specifying unit 124 acquires the situation of each of the plurality of charging facilities 4. The situation of the charging facility 4 includes, for example, whether or not another flight device 3 is currently landed on the charging facility 4, and the weather around the charging facility 4.

For example, in a case where the situation of the charging facility 4 closest to the flight device 3 out of the plurality of charging facilities 4 does not satisfy a predetermined condition, the specifying unit 124 selects the charging facility 4 next closest to the flight device 3 as the charging facility 4 for charging the battery of the flight device 3. For example, the condition of the situation is such that another flight device 3 is not landed on the charging facility 4, or the wind speed around the charging facility 4 is less than or equal to a predetermined value. Accordingly, the flight control apparatus 1 can select the charging facility 4 appropriately used for charging by the flight device 3 by considering the situation of each of the plurality of charging facilities 4.

After the specifying unit 124 specifies the charging facility 4 for charging the battery of the flight device 3, the specifying unit 124 specifies a charging path that includes a path from the position of the flight device 3 to the specified charging facility 4 and a path from the specified charging facility 4 to the flight path.

For example, the charging path includes a path from a deviation position at which the flight device 3 starts flying along the charging path to the specified charging facility 4, and a path from the specified charging facility 4 to the deviation position. The deviation position is, for example, the position of the flight device 3 at a point in time immediately after the remaining capacity of the battery is less than or equal to the threshold value, or a position advanced by a predetermined distance from the position of the flight device 3 at the point in time immediately after the remaining capacity of the battery is less than or equal to the threshold value. The specifying unit 124 may specify a straight linear path from the deviation position to the charging facility 4 as the charging path or may specify a path from the deviation position to the charging facility 4 decided using known path decision processing as the charging path.

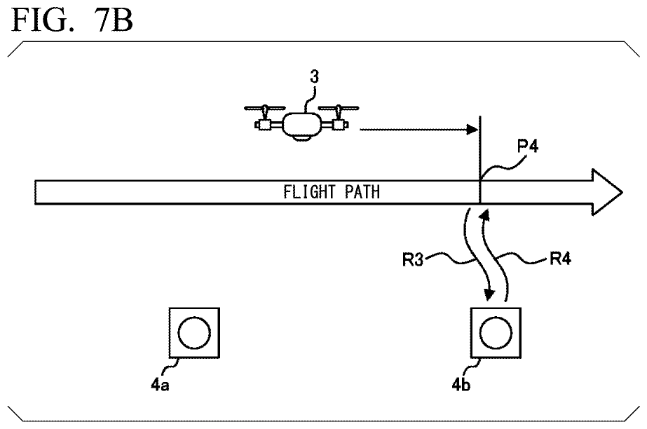

FIG. 7A and FIG. 7B are schematic diagrams for describing the charging path specified by the specifying unit 124. FIG. 7A represents an example in which the position of the flight device 3 at the point in time immediately after the remaining capacity of the battery is less than or equal to the threshold value is referred to as a deviation position P3. The specifying unit 124 specifies the charging path including a path R1 from the deviation position P3 to the specified charging facility 4a and a path R2 from the specified charging facility 4a to the deviation position P3. Accordingly, the flight control apparatus 1 can issue an instruction for an appropriate charging path to the flight device 3 in accordance with the position of the flight device 3.

FIG. 7B represents an example in which the position advanced by the predetermined distance from the position of the flight device 3 at the point in time immediately after the remaining capacity of the battery is less than or equal to the threshold value is referred to as a deviation position P4. The specifying unit 124 specifies the charging path including a path R3 that reaches the specified charging facility 4b from the position of the flight device 3 via the deviation position P4, and a path R4 from the specified charging facility 4b to the deviation position P4. Accordingly, for example, in a case where the specified charging facility 4 is positioned ahead of the flight device 3 along the flight path, the flight control apparatus 1 can cause the flight device 3 to start moving to the charging facility 4 after advancing a certain distance. Thus, a travel from the flight device 3 to the charging facility 4 can be shortened, and the flight of the flight device 3 can be efficiently performed.

In addition, in FIG. 7A and FIG. 7B, the paths R1 and R3 from the flight path to the charging facility 4 and the paths R2 and R4 from the charging facility 4 to the flight path may be the same or different from each other.

While the flight device 3 returns to the deviation position after charging in the examples in FIG. 7A and FIG. 7B, the flight device 3 may return to a position different from the deviation position on the flight path. That is, for example, the charging path may include the path from the deviation position at which the flight device 3 starts flying along the charging path to the specified charging facility 4, and a path from the specified charging facility 4 to a return position different from the deviation position on the flight path. In this case, the return position is desirably a position advanced by a predetermined distance from the deviation position along the flight path. Accordingly, the flight control apparatus 1 can cause the flight device 3 to complete the flight on the flight path early after charging.

The flight control unit 122 performs a control for charging the battery by causing the flight device 3 to fly to the charging facility 4 specified by the specifying unit 124 and then, causing the flight device 3 to fly to the flight path, if the remaining capacity of the battery acquired by the battery remaining capacity acquisition unit 123 is less than or equal to the threshold value specified by the specifying unit 124 while the flight device 3 flies along the flight path. For example, the flight control unit 122 transmits control information for flying along the charging path specified by the specifying unit 124 to the flight device 3. The flight device 3 flies to the charging facility 4, charges the battery, and then, flies to the flight path along the charging path included in the control information received from the flight control apparatus 1.

In a case where the flight device 3 functions as the flight control apparatus 1, the flight control unit 122 included in the flight device 3 outputs the control information (for example, a control signal) for flying along the charging path specified by the specifying unit 124 to the driving unit such as the motor included in the flight device 3. Accordingly, the flight device 3 flies to the charging facility 4, charges the battery, and then, flies to the flight path along the charging path.

With such a configuration, the flight control apparatus 1 can cause the flight device 3 flying along the designated flight path to fly to the charging facility 4 specified in accordance with the position of the flight device 3 and the remaining capacity of the battery and charge the battery.

In addition, after the flight device 3 flies to the charging facility 4, the flight control unit 122 may adjust a timing at which the flight device 3 returns to the flight path, based on the remaining capacity of the charged battery. In this case, the battery remaining capacity acquisition unit 123 acquires the remaining capacity of the battery charged in the charging facility 4 after the flight device 3 starts charging the battery in the charging facility 4. The flight control unit 122 performs a control for causing the flight device 3 to fly to the flight path if the remaining capacity of the battery acquired by the battery remaining capacity acquisition unit 123 is greater than or equal to a value corresponding to the remaining length of the flight path.

The remaining capacity of the battery corresponding to the remaining length of the flight path is, for example, the remaining capacity of the battery that is calculated using the relationship table or the relationship expression, stored in advance in the storage unit 11, which indicates the relationship between the remaining capacity of the battery of the flight device 3 and the flyable distance of the flight device 3, and with which the flight device 3 can fly a distance in which the flight device 3 returns to the flight path from the charging facility 4 and reaches the end point of the flight path. Accordingly, the flight control apparatus 1 can charge the battery with electric power sufficient for completing the flight of the flight device 3 on the flight path.

In addition, the flight control unit 122 may perform a control for causing the flight device 3 to fly to the flight path if the remaining capacity of the battery acquired by the battery remaining capacity acquisition unit 123 is greater than or equal to a value corresponding to the remaining length of the flight path and a remaining work to be performed on the flight path by the flight device 3. Accordingly, the flight control apparatus 1 can charge the battery with electric power sufficient for completing the work to be performed on the flight path by the flight device 3.

### Sequence of Flight Control Method

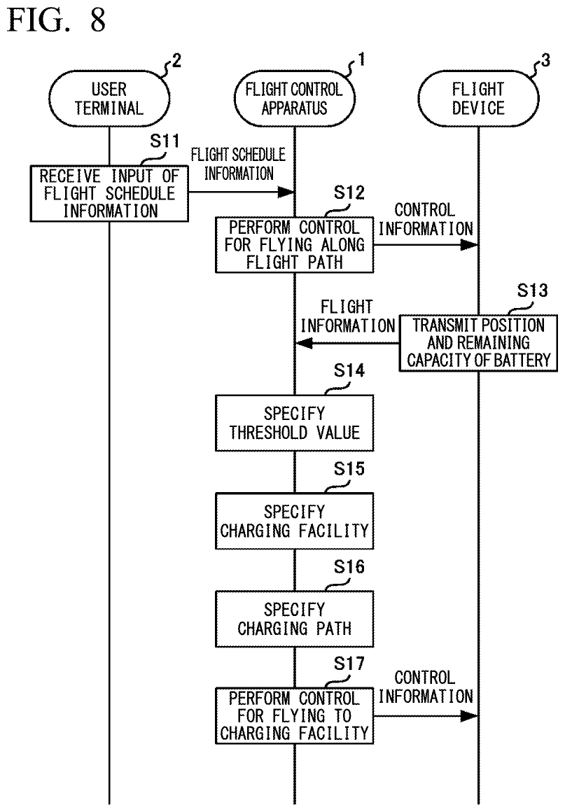

FIG. 8 is a diagram illustrating a sequence of a flight control method executed by the flight control system. The user terminal 2 receives the input of the flight schedule information on the flight schedule screen (S11). Specifically, for example, the user terminal 2 receives the planar range (flight area) designated on the map displayed on the flight schedule screen as the flight range. In addition, the user terminal 2 receives the linear path designated in the flight range on the map displayed on the flight schedule screen as the flight path.

In the flight control apparatus 1, the flight path acquisition unit 121 acquires the flight schedule information including the flight path from the user terminal 2. The flight path acquisition unit 121 stores the flight schedule information received from the user terminal 2 in the storage unit 11.

The flight control unit 122 performs the control for causing the flight device 3 to fly along the flight path acquired by the flight path acquisition unit 121 (S12). For example, the flight control unit 122 transmits the control information for flying along the flight path acquired by the flight path acquisition unit 121 to the flight device 3. The flight device 3 flies using the electric battery power along the flight path included in the control information received from the flight control apparatus 1.

While the flight device 3 flies along the flight path, the flight device 3 specifies the remaining capacity of the battery based on, for example, the voltage and specifies the position based on the GPS signal or the base station (cell) with which the flight device 3 can communicate. The flight device 3 transmits the flight information including the specified remaining capacity of the battery and the position of the flight device 3 to the flight control apparatus 1 (S13).

The specifying unit 124 specifies the threshold value used for determining the remaining capacity of the battery (S14). The specifying unit 124 may specify the sequential threshold value while the flight device 3 flies, or may specify the threshold value in advance before the flight device 3 flies. The specifying unit 124 specifies the charging facility 4 for charging the battery of the flight device 3 if the remaining capacity of the battery is less than or equal to the specified threshold value (S15).

After the specifying unit 124 specifies the charging facility 4 for charging the battery of the flight device 3, the specifying unit 124 specifies the charging path that includes the path from the position of the flight device 3 to the specified charging facility 4 and the path from the specified charging facility 4 to the flight path (S16).

The flight control unit 122 performs the control for charging the battery by causing the flight device 3 to fly to the charging facility 4 specified by the specifying unit 124 and then, causing the flight device 3 to fly to the flight path, if the remaining capacity of the battery acquired by the battery remaining capacity acquisition unit 123 is less than or equal to the threshold value specified by the specifying unit 124 while the flight device 3 flies along the flight path (S17). For example, the flight control unit 122 transmits the control information for flying along the charging path specified by the specifying unit 124 to the flight device 3.

### Effect of Embodiment

The flight control apparatus 1 according to the present embodiment dynamically specifies the charging facility 4 in accordance with the position of the flight device 3 flying along the designated flight path and the remaining capacity of the battery, and charges the battery by causing the flight device 3 to fly to the specified charging facility 4. Accordingly, according to the flight control apparatus 1, since the charging facility 4 to be used for charging the battery on the flight path does not need to be decided in advance, the flight device 3 can continue flying by charging the battery under various situations such as a case where the remaining capacity of the battery is quickly reduced due to an effect of a headwind.

Accordingly, for example, an environment in which the drone can fly can be created even in an urban area and a mountainous area covered by a wireless network. Thus, a contribution can be made to Goal 9 “Industry, Innovation and Infrastructure” and Goal 10 “Reduced Inequalities” of Sustainable Development Goals (SDGs) led by the United Nations.

While the present invention is described above using the embodiment, the technical scope of the present invention is not limited to the scope disclosed in the embodiment, and various modifications and changes can be made within the scope of the gist of the present invention. For example, all parts or a part of the apparatus can be configured by functional or physical distribution or integration in any units. In addition, the embodiment of the present invention includes a new embodiment that results from any combination of a plurality of embodiments. An effect of the new embodiment resulting from the combination also has the effect of the original embodiment.

Processors of the flight control apparatus 1, the user terminal 2, and the flight device 3 are entities of each step (process) included in the flight control method illustrated in FIG. 8. That is, the processors of the flight control apparatus 1, the user terminal 2, and the flight device 3 execute the flight control method illustrated in FIG. 8 by reading a program for executing the flight control method illustrated in FIG. 8 from a storage unit and executing the program. A part of the steps included in the flight control method illustrated in FIG. 8 may be omitted. An order of the steps may be changed. A plurality of steps may be performed in parallel.

What is claimed is:

1. A flight control apparatus for controlling a flight device operating by electric battery power supplied from a battery, the flight control apparatus comprising:
a flight path acquisition unit that acquires a flight path;
a flight control unit that causes the flight device to fly along the flight path;
a battery remaining capacity acquisition unit that acquires a remaining capacity of the battery; and
a specifying unit that specifies a charging facility for charging the battery, which corresponds to a position of the flight device,
wherein the flight control unit causes the flight device to fly to the specified charging facility and charge the battery, and then, causes the flight device to fly to the flight path, if the remaining capacity is less than or equal to a threshold value while the flight device flies along the flight path.

2. The flight control apparatus according to claim 1, wherein the specifying unit specifies the charging facility closest to the position of the flight device if the remaining capacity is less than or equal to the threshold value.

3. The flight control apparatus according to claim 1, wherein
the specifying unit specifies a charging path including a path from the position of the flight device to the specified charging facility and a path from the specified charging facility to the flight path, if the remaining capacity is less than or equal to the threshold value, and
the flight control unit causes the flight device to fly along the charging path if the remaining capacity is less than or equal to the threshold value while the flight device flies along the flight path.

4. The flight control apparatus according to claim 3, wherein the specifying unit specifies the charging path including a path from a position at which the flight device starts flying along the charging path to the specified charging facility, and a path from the specified charging facility to the position at which the flight device starts flying along the charging path.

5. The flight control apparatus according to claim 3, wherein the specifying unit specifies the charging path including a path from a deviation position advanced by a predetermined distance from a position at which the remaining capacity is less than or equal to the threshold value to the specified charging facility, and a path from the specified charging facility to the deviation position.

6. The flight control apparatus according to claim 1, wherein, while the flight device flies along the flight path, the specifying unit specifies the threshold value based on a relationship between the position of the flight device and a position of the charging facility.

7. The flight control apparatus according to claim 6, wherein the specifying unit specifies the threshold value based on a remaining work to be performed on the flight path by the flight device, in addition to the relationship.

8. The flight control apparatus according to claim 6, wherein the specifying unit specifies the threshold value based on a remaining length of the flight path, in addition to the relationship.

9. The flight control apparatus according to claim 6, wherein the specifying unit specifies the threshold value based on characteristics of the flight device, in addition to the relationship.

10. The flight control apparatus according to claim 6, wherein
the specifying unit specifies a plurality of the threshold values corresponding to a relationship between the position of the flight device and a position of each of a plurality of the charging facilities, and
the flight control unit causes the flight device to fly to any of the plurality of charging facilities based on situations of the plurality of charging facilities and the plurality of threshold values.

11. The flight control apparatus according to claim 1, wherein the specifying unit specifies the threshold value corresponding to a relationship, stored in advance in a storage unit, between any position on the flight path and a position of the charging facility.

12. The flight control apparatus according to claim 10, wherein the specifying unit specifies the threshold value corresponding to the relationship, stored in advance in the storage unit, between any position on the flight path and the position of the charging facility and characteristics of the flight device.

13. The flight control apparatus according to claim 1, wherein the flight control unit causes the flight device to fly to the flight path if the remaining capacity is greater than or equal to a value corresponding to a remaining length of the flight path after the flight device starts charging in the specified charging facility.

14. The flight control apparatus according to claim 13, wherein the flight control unit causes the flight device to fly to the flight path if the remaining capacity is greater than or equal to a value corresponding to the length and a remaining work to be performed on the flight path by the flight device after the flight device starts charging in the specified charging facility.

15. The flight control apparatus according to claim 1, wherein:
the specifying unit specifies, if the remaining capacity is less than or equal to the threshold value, a charging path including a path from a deviation position on the flight path at which the flight device starts flying along the charging path to the specified charging facility, and a path from the specified charging facility to a return position equal to or different from the deviation position on the flight path; and
the flight control unit causes the flight device to fly along the charging path to the specified charging facility to charge the battery, and then causes the flight device to fly along the charging path to the flight path.

16. The flight control apparatus according to claim 1, wherein the flight device performs a work including imaging or monitoring on the flight path.

17. The flight control apparatus according to claim 16, wherein:
the specifying unit specifies a charging path including a path from a deviation position on the flight path at which the flight device starts flying along the charging path to the specified charging facility and a path from the specified charging facility to the deviation position on the flight path; and
the flight device performs the work including imaging or monitoring on an entirety of the flight path.

18. The flight control apparatus according to claim 1, wherein:
the specifying unit specifies a charging path including a path from a deviation position on the flight path at which the flight device starts flying along the charging path to the specified charging facility and a path from the specified charging facility to a return position on the flight path; and
the return position is a position advanced by a predetermined distance from the deviation position along the flight path.

19. A flight control method for controlling a flight device operating by electric battery power supplied from a battery, the flight control method executed by a processor, comprising:
acquiring a flight path;
causing the flight device to fly along the flight path;
acquiring a remaining capacity of the battery;
specifying a charging facility, corresponding to a position of the flight device, for charging the battery; and
causing the flight device to fly to the specified charging facility and charge the battery, and then, causing the flight device to fly to the flight path, if the remaining capacity is less than or equal to a threshold value while the flight device flies along the flight path.
